(19) United States
(12) Patent Application Publication
(10) Pub. No.: US 2019/0017324 A1
(43) Pub. Date: Jan. 17, 2019

(54) MOVABLE LADDER

(71) Applicant: Grupo Bimbo, S. A. B. de C. V., Mexico (MX)

(72) Inventor: Armando Israel AGUILUZ FLORES, Jilotepec (MX)

(21) Appl. No.: 15/735,070

(22) PCT Filed: Sep. 30, 2015
(86) PCT No.: PCT/MX2015/000134

§ 371 Date: Sep. 25, 2018

(30) Foreign Application Priority Data
Jun. 10, 2015 (MX) MX/U/2015/000313

(51) Int. Cl. E06C 1/39

(52) U.S. Cl. CPC E06C 1/39

(57) ABSTRACT

Disclosed is a movable ladder formed by a structural element composed of a rear part and two sides, the lower part of the vertical structural elements of the ladder terminating in lateral projections in the form of an inverted “U” that provide the ladder with reliable support on the floor. The ladder is characterised in that it is provided with two collapsible lateral platforms and four wheels that can be raised or lowered to facilitate the movement of the ladder toward the work area.

The present application refers to a movable ladder, provided with folding side platforms for the placement of work tools or various articles for their subsequent placement on shelves, as well as with ascending and descending wheels to facilitate the attachment of the ladder in the workplace or its easy movement on the surface of the floor.

Currently, there are several types of ladders, some of them are of great length, which require for their use to be supported on a wall, a post or some other means that keeps them in an inclined position in order to carry out repairs or work at considerably great heights. There are also folding scissor-shaped ladders on the market, which are widely used in the repair areas, the pruning of low trees, etc. The ladder we are making reference to is a ladder with a construction and utility that has been designed to carry out repair work at low heights, to move various articles for their subsequent placement on shelves or for specialized work where it is required to transport on these ladders the tools and/or products that will be used in the repair of walls, or as already mentioned before, to transport on them diverse articles, which will be subsequently placed on shelves at lower heights.

The movable ladder of the invention essentially consists of a frame or metal structure, which supports at least two steps as well as two folding side platforms. This ladder can remain fixed when in use or can be moved by means of four casters, which facilitate the movement of this ladder towards the work area.

Most of the above-mentioned ladders are foldable type ladders having the purpose that once unoccupied, they can be stored occupying minimal spaces. It is worth mentioning that ladders that could be considered prior art are those protected in U.S. Pat. D1146094A, patent CN201048733Y, patent CN201048733Y, the English patent GB19551364A, in addition to many others, which can be considered as prior art without thereby invalidating the novelty of the movable ladder, which is the object of the present application.

### OBJECTIVES OF THE INVENTION

It is an objective of the invention to provide a movable ladder, which is provided with elements that keep it stable while it is in use and which permits the transporting on it work tools or articles that are intended to be placed on shelves at a moderately elevated height.

Another objective of the invention is the construction and design of a movable ladder equipped with folding side platforms for the transportation of products and/or work tools.

It is another objective of the invention to provide a movable ladder with unique features, allowing the user to achieve variable heights for the placement of diverse articles on shelves of supermarkets or service stores, or to facilitate the repair of walls and/or some other services that must be carried out at a height greater than that available to an operator of average height.

The invention that is subject of the present application will be fully understood by means of the accompanying drawings, which fully illustrate the advantages that the movable ladder of the invention offers, advantages that distinguish it from other ladders of its kind.

### DESCRIPTION OF DRAWINGS

FIG. 1 is a perspective view of the movable ladder of the invention, in which one of its platforms is shown collapsed;

FIG. 2 is a top plan view of the ladder in question;

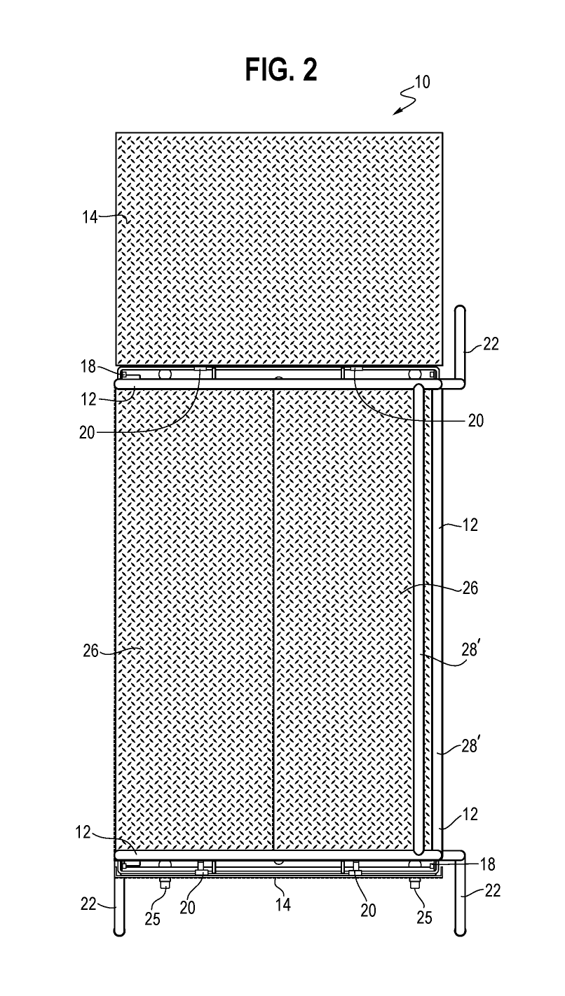

FIG. 3 is an elevation view of the back of the ladder;

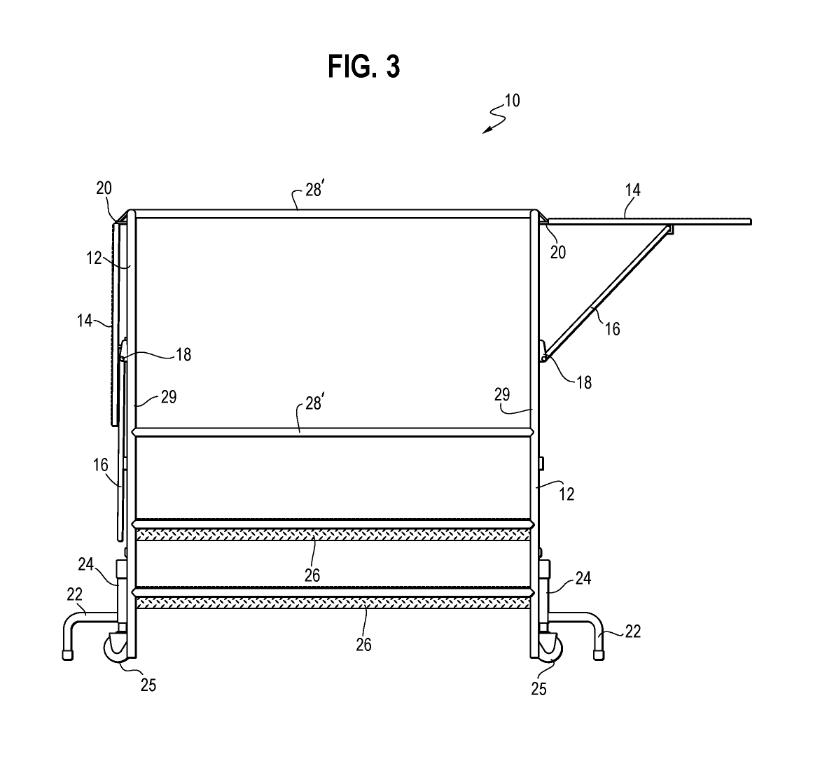

FIG. 4 is an elevation view of the right side of said ladder, with its platform collapsed.

### DETAILED DESCRIPTION OF THE INVENTION

The movable ladder 10, subject of the present application, consists of a structural frame 12, which has a rear part and two side faces, both the rear part of said structure 12 and the side parts have structural elements 28′ and 29. The structural elements 29 have in their lower part side projections 22 in the form of an inverted “U”, which act like the legs of the ladder when in use, and keep said ladder firmly supported on the floor. Note that said legs 22, which to a certain extent constitute an extension of the structural elements 29, project slightly outwards, with the purpose of providing the ladder with greater stability.

As part of the structural elements of the ladder 12, object of the present invention, said ladder has two side platforms 14, which are suitably hinged to the side structural elements 28′, by means of a pair of hinges 20, said platforms 14 are maintained in their horizontal position through the means identified with reference 16, which can be rotated downwards or upwards in the brackets 18. One of ordinary skill in the art will readily appreciate that said structural means 16 are hooked by the lower part of the platforms 14 when the use of them is required.

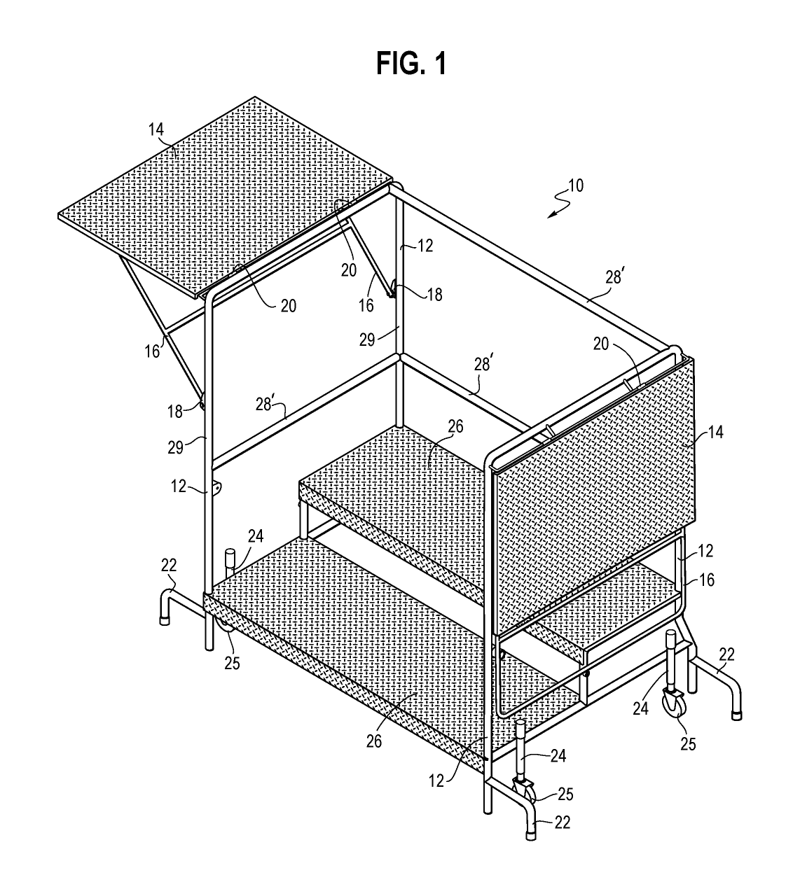

In the main FIG. 1, the collapse of the platforms 14 can be observed. To collapse the platform 14, the only thing needed to be done is to unhook the supporting means 16, by rotating it downwards as well as the respective platform 14. It is important to note that for the first time a movable ladder with two side platforms 14 having dimensions that may vary according to the intended use is offered to the market.

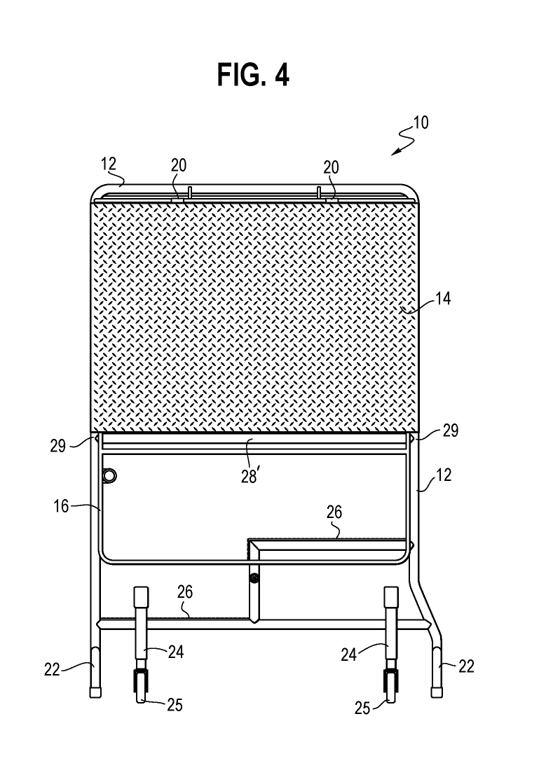

From FIGS. 1 and 4, it is noted that said ladder is provided with four wheels or casters 25, which can be retracted or lowered, depending on whether said ladder 10 is being used or not. One of ordinary skill in the art with reference to the subject specification and figures will readily appreciate that when said ladder is in use, said casters 25 will have to be retracted such that said ladder 10 will have an adequate support on the floor by means of the side legs 22. Said casters 25 are fixedly and permanently mounted on the structural element 28, with the aid of the devices 24 which are no more than tubular elements either internally threaded or with perforations, for the insertion of a coach screw with the purpose of fixing the position of said casters 25.

Finally, it should be noted from the accompanying figures that the movable ladder of the invention has two steps 26 and 26′; the number of steps can vary according to the needs and use to which said ladder is intended.

From the detailed description that has been offered herein, it is evident that the objectives or purposes of the invention have been fully met and that due to the very particular structural configuration of the ladder of the invention, it offers advantages and has particular features that distinguish it from those of its kind.

Structural and design changes or modifications can be made to the movable ladder of the invention, without constituting a different invention, as long as the proposed changes are part of the invention subject matter and are within the spirit and scope of the claims that are offered below.

1. (canceled)

2. (canceled)

3. (canceled)

4. (canceled)

5. A movable ladder (10) comprising:
a frame (12) comprising:
a first side portion and a second side portion, the first and second side portions each comprising a first vertical structural element (29), a second vertical structural element, and a side horizontal structural element (28′), where the side horizontal structural element adjoins the first vertical structural element to the second vertical structural element, and where the first vertical structural element and second vertical structural element each comprises a lateral projection (22); and
a rear horizontal structural element, where the rear horizontal structural element adjoins the first side portion and second side portion;
a hinge (20) disposed on the side horizontal structural element of each of the first side portion and second side portion;
a collapsible platform (14) adjoined to each of the first side portion and second side portion via the hinge;
at least one caster (25) adjoined to the frame; and
at least two steps (26) mounted to the frame.

6. The movable ladder of claim 5, further comprising a support mechanism (16) for maintaining the collapsible platform in a horizontal position.

7. The movable ladder of claim 6, where the support mechanism comprises a rod.

8. The movable ladder of claim 7, further comprising a bracket (18) mounted to the vertical side element of the first and second side portions, where a first end of the rod is inserted into the bracket and where the collapsible platform is maintained in a horizontal position by rotating the rod upward within the bracket and maintained in a vertical position by rotating the rod downward within the bracket.

9. The movable ladder of claim 5, further comprising:
a second side horizontal structural element (28′) adjoining a bottom end of the first vertical structural element (29) of the first side portion to a bottom end of the second vertical structural element of the first side portion; and
a third side horizontal structural element (28′) adjoining a bottom end of the first vertical structural element (29) of the second side portion to a bottom end of the second vertical structural element of the second side portion.

10. The movable ladder of claim 10, where two casters are adjoined to the second side horizontal structural element.

11. The movable ladder of claim 11, where two casters are adjoined to the third side horizontal structural element.

12. The movable ladder of claim 5, where the lateral projection comprises the shape of a substantially inverted u.

13. The movable ladder of claim 5, where the caster can be lowered to move the movable ladder and raised such that movement is substantially prevented.

14. The movable ladder of claim 5, further comprising a tubular element adjoining the caster to the frame.

15. The movable ladder of claim 5, where the collapsible platform is positioned near a top of the vertical structural element.

16. The movable ladder of claim 5, where the first side portion is disposed substantially parallel to the second side portion of the frame.
